(19) United States
(12) Patent Application Publication
(10) Pub. No.: US 2020/0263036 A1
(43) Pub. Date: Aug. 20, 2020

(54) TREATED WOOD COMPOSITE MATERIALS AND RELATED METHODS OF USE

(71) Applicant: JELD-WEN, Inc., Charlotte, NC (US)

(72) Inventors: Bob Bender, Charlotte, NC (US); Peter A. Smith, Charlotte, NC (US); Jerry D. Jones, Klamath Falls, OR (US)

(21) Appl. No.: 16/793,165

(22) Filed: Feb. 18, 2020

Related U.S. Application Data
(60) Provisional application No. 62/807,739, filed on Feb. 19, 2019.

(51) Int. Cl. C08L 97/02; C08L 27/06; C08K 5/3472; C08K 5/3477; B27N 3/02; B27N 3/08; B27N 1/00

(52) U.S. Cl. CPC C08L 97/02; C08L 27/06; C08K 5/3472; B27N 1/00; B27N 3/02; B27N 3/08; C08K 5/3477

(57) ABSTRACT

Treated wood composite materials including a wood component and a plastic component are disclosed. The wood component can include wood flour. The treated wood composite materials can further include a treatment formulation. The treatment formulation can be applied to the wood composite materials at various stages in the manufacturing process, and can also be applied in various ways.

### RELATED APPLICATIONS

This application claims priority to U.S. Provisional Application No. 62/807,739, filed on Feb. 19, 2019, and titled TREATED WOOD COMPOSITE MATERIALS AND RELATED METHODS OF USE, which is incorporated herein by reference in its entirety.

### TECHNICAL FIELD

The present disclosure relates to treated wood composite materials and related methods of use.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1 is a diagram of a process for treating wood material in accordance with one embodiment of the present disclosure.

FIG. 2 is a diagram of another process for treating wood material in accordance with another embodiment of the present disclosure.

FIG. 3 is a diagram of another process for treating wood material in accordance with another embodiment of the present disclosure.

FIG. 4 is a diagram of another process for treating wood material in accordance with another embodiment of the present disclosure.

FIG. 5 is a diagram of another process for treating wood material in accordance with another embodiment of the present disclosure.

FIG. 6 is a diagram of another process for treating wood material in accordance with another embodiment of the present disclosure.

### DETAILED DESCRIPTION

Building structures, such as windows and doors, are often made using wood and/or wood composite materials. These wood and wood composite materials are aesthetically pleasing but can be susceptible to damage caused by long-term exposure to humid or dry air, moisture, weather, fungal infestation, and/or insects and pests. The various embodiments disclosed herein generally relate to wood composite materials that have been treated with a treatment formulation to enhance the ability of the wood composite material to resist deterioration, such as that caused by exposure to humid or dry air, moisture, weather, fungal infestation, and/or insects and pests.

As further detailed below, the treated wood composite materials can include a wood component and a plastic component. The treated wood composite materials can further include a treatment formulation. The treatment formulation can be applied to the wood composite materials at various stages in the manufacturing process, and can further be applied in various ways, some of which are detailed below.

Various types of wood can be used as the wood component of the composite materials disclosed herein. For example, in some embodiments, the wood component comprises one or more of a hard wood, a soft wood, or combinations thereof. In particular embodiments, the wood component comprises a hard wood. Exemplary hard wood species that can be used include, but are not limited to, wood derived from dicotyledonous trees, such as cherry, ash, mahogany, troko, beech, oak, maple, birch, walnut, teak, alder, aspen, beech, cottonwood, elm, gum, poplar, willow, and combinations thereof. Exemplary soft wood species that can be used include, but are not limited to, wood derived from coniferous trees, such as larch, pine, fir, Douglas fir, hemlock, redwood, spruce, and combinations thereof. Other species of wood can also be used.

The wood component can also comprise various types and/or sizes of wood particles. Exemplary types of wood particles that can be used include, but are not limited to, wood chips, curls, flakes, slivers, strands, shavings (e.g., sawmill shavings), sawdust, wood flour, and combinations thereof. In some embodiments, the wood component comprises wood flour. Wood flour can be used to describe finely divided wood particles or fibers. In certain embodiments, the wood flour comprises a particle size of between about 20 mesh and about 270 mesh, such as between about 20 mesh and about 100 mesh, between about 100 mesh and about 200 mesh, or between about 150 mesh and about 270 mesh. In certain embodiments, the mesh size can be determined by sonic sifting or sonic sieving methods.

If desired, the wood component can also comprise other types of lignocellulosic materials, including, but not limited to, straw, hemp, sisal, cotton stalk, wheat, bamboo, jute, salt water reeds, palm fronds, flax, nut shells, and combinations thereof. These lignocellulosic materials can be used in combination with, or in place of, the wood particles and/or wood flour. For example, fibers, particles, and/or flour comprising one or more of the various lignocellulosic materials can be used.

In embodiments where wood flour is used as the wood component, the wood flour can also comprise a particular aspect ratio. This aspect ratio is the ratio of the diameter to the length of the wood flour particles or fibers. In some embodiments, the wood flour comprises a diameter to length aspect ratio of between about 1:1 (diameter:length) and about 1:10 (diameter:length), between about 1:1 (diameter:length) and about 1:7 (diameter:length), between about 1:1 (diameter:length) and about 1:5 (diameter:length), or between about 1:1 (diameter:length) and about 1:3 (diameter:length). Exemplary wood flour particles or fibers can be between about 0.3 mm and about 1.55 mm in diameter, and between about 1 and about 10 mm in length. Other sizes of wood flour particles or fibers can also be used.

Wood flour can be obtained in various ways. In certain embodiments, the wood flour is derived from by-products of sawing or milling. In other embodiments, larger wood pieces (e.g., wood chips and/or shavings) can be processed, ground, or otherwise pulverized into wood flour that can be used in accordance with the present disclosure. For instance, wood pieces, wood chips, sawdust, and/or wood shavings can be processed into wood flour through use of one or more mechanical implements. In still other embodiments, wood flour can be obtained from larger wood planks or lumber that are processed, chopped, ground, and/or pulverized into wood flour (e.g., through the use of one or more mechanical implements). It will thus be appreciated that the wood flour can be obtained from various types and/or sizes of wood materials. In some embodiments, the wood flour is derived from two or more different sources.

As further detailed herein, the wood component can be treated with a treatment formulation. Various types of treatment formulations and/or methods can be used, some of which are described in U.S. Pat. Nos. 6,686,056, 6,569,540, 6,274,199, 5,824,370, 5,652,023, and 9,339,943, each of which is incorporated herein by reference in its entirety. In some embodiments, the treatment formulation comprises one or more of a fungicide, a preservative, an insecticide, and/or a pesticide. In a particular embodiment, the treatment formulation comprises one or more of a fungicide and/or an insecticide. Additional components can also be included in the treatment formulation to provide added properties if desired. For example, the treatment formulation can comprise components that can facilitate permeation of the active ingredients (e.g., fungicide, preservative, insecticide, pesticide, etc.) into the wood material. The treatment formulation can also comprise components that repel water (e.g., water repellents). In some of such embodiments, the treatment formulation further comprises one or more of water, a surfactant (e.g., nonionic, anionic, amphoteric surfactant, etc.), an oil, an emulsifier, a fire retardant, a fragrance, a wax, a water repellent, an adhesive, and/or a binder.

Illustrative fungicides that can be used in accordance with the present disclosure include, but are not limited to, chromated copper arsenate, borates, azoles, triazoles, alkaline copper, alkaline copper quaternary salts, alkaline copper zinc arsenates, epoxyconazole, hexaconazole, azaconazole, propiconazole, tebuconazole, cyproconazole, metconazole, imazalil, dichlorofluanide, tolylfluanide, 3-iodo-2-propinylbutyl carbamate, N-octylsothiazolin-3-one and 4,5-dichloro-N-octylisothiazolin-3-one, quaternary ammonium compounds, isothiazolones, and carbamates. In a particular embodiment, the treatment formulation comprises tebuconazole.

While the amount of treatment formulation that is incorporated into the wood component can vary, in some embodiments the treated wood component comprises a tebuconazole (or another fungicide) content of between about 100 ppm and about 10,000 ppm, such as between about 250 ppm and about 10,000 ppm, between about 500 ppm and about 10,000 ppm, between about 500 ppm and about 7,500 ppm, between about 500 ppm and about 5,000 ppm, between about 500 ppm and about 2,500 ppm, between about 500 ppm and about 2,000 ppm, between about 500 ppm and about 1,500 ppm, between about 500 ppm and about 1,250 ppm, between about 500 ppm and about 1,000 ppm, between about 600 ppm and about 800 ppm, or between about 650 ppm and about 750 ppm. In further embodiments, the treated wood component comprises greater than about 100 ppm, greater than about 250 ppm, greater than about 500 ppm, greater than about 600 ppm, greater than about 700 ppm, greater than about 800 ppm, or greater than about 900 ppm of tebuconazole (or another fungicide). Other amounts of tebuconazole (or another fungicide) can also be used. The amount of tebuconazole (or another fungicide) can be determined in various ways, such as through the use of gas chromatography or gas-liquid partition chromatography (GPLC).

Illustrative insecticides that can be used in accordance with the present disclosure include, but are not limited to, chlorpyriphos, phoxim, silafluofin, alphamethrin, cyfluthrin, cypermethrin, deltamethrin, permethrin, imidacloprid, flufenoxuron, hexaflumuron and triflumuron. In a particular embodiment, the treatment formulation comprises imidacloprid.

In certain embodiments, the treatment formulation comprises tebuconazole and imidacloprid. And in some of such embodiments, the treatment formulation further comprises one or more of a binder (e.g., texanol or 2,2,4-Trimethyl-1,3-pentanediol monoisobutyrate), a surfactant, an emulsifier, and a water repellent. For example, in particular embodiments, the treatment formulation comprises tebuconazole, imidacloprid, a binder (e.g., texanol or 2,2,4-Trimethyl-1,3-pentanediol monoisobutyrate), a surfactant, an emulsifier, and a water repellent. Other components can also be used. In one embodiment, the treatment formulation includes approximately 1.0% to 2.0% tebuconazole and approximately 0.020% to 0.030% imidacloprid. The treatment formulation may comprise approximately 20% to 25% water repellant and stabilizers, based on measurement of solids in the treatment formulation.

The viscosity of the treatment formulation can be modified as needed (e.g., by dilution, depending on the application method employed). In certain embodiments, the viscosity of the treatment formulation is between about 1 and about 5 centipoise, between about 1 and about 3 centipoise, or between about 1 and about 2 centipoise. Modifying the viscosity can help in embodiments wherein the treatment formulation is sprayed onto the wood materials and/or wood particles.

In some embodiments, the wood component can be treated with a treatment formulation prior to being combined with a plastic component to form a wood composite material. In other embodiments, the wood component can be treated with a treatment formulation after being combined with a plastic component to form a wood composite material. For example, the wood and plastic components can be combined and formed into wood composite pellets, after which the pellets can be treated with a treatment formulation. In still further embodiments, the wood and plastic components can be formed into a wood composite material that is comprised in a building structure, after which the structure is treated with a treatment formulation.

In embodiments where the wood component is treated prior to formation of the wood composite material, the wood component can be treated at various stages and/or various particle sizes. For instance, in some embodiments, larger wood planks, lumber, or wood pieces can be treated with a treatment formulation. In such embodiments, various known wood treatment methods can be used, such as those described in U.S. Pat. Nos. 6,274,199, 5,824,370, 5,652,023, and 9,339,943, each of which is incorporated herein by reference in its entirety.

In certain of such embodiments, the method of treatment comprises one or more of the following steps: subjecting the wood material to a vacuum (or reduced pressure); contacting the wood material with a treatment formulation (which can optionally be heated); subjecting the wood material to positive pressure; and subjecting the wood material to elevated temperature. For example, in various embodiments, the method comprises subjecting the wood material to a vacuum that is sufficient to remove air from at least a portion of the cells in the wood material. The method can further comprise contacting the wood material with a treatment formulation, and applying a positive pressure to enhance penetration of the treatment formulation into the wood material. In some of such embodiments of the method, the temperature may be increased and/or adjusted to maximize penetration of the treatment formulation into the wood material. The treatment formulation can also optionally be heated. After a period sufficient for substantial penetration into the wood material by the treatment formulation, the positive pressure in the treatment vessel may be released, and any excess (i.e., nonadsorbed) treatment formulation may be removed from the treatment vessel. The pressure in the treatment vessel may then be further reduced below atmospheric pressure. Employing a vacuum in the treatment vessel may help to remove at least some of the moisture remaining in the wood material after treatment with the treatment formulation.

In one exemplary embodiment, the treatment method comprises subjecting the wood material to a vacuum for at least about 3 minutes, about 5 minutes, or about 10 minutes. The wood material can then be contacted with a treatment formulation (which can optionally be heated to at least about 140° F., about 150° F., about 160° F., 170° F., or more, and in some embodiments between 150° F. and 165° F.) for at least about 7 minutes, about 10, minutes, or about 12 minutes. The wood material can then be subjected to a positive pressure for at least about 30 minutes, about 45 minutes, about 60 minutes, about 75 minutes, or about 90 minutes. The positive pressure can then be released and the excess treatment formulation can be removed from the treatment vessel. If desired, the wood material can then be subjected to a second vacuum for at least about 20 minutes, about 30 minutes, about 40 minutes or about 50 minutes, or more, to remove excess treatment formulation. Other method steps can also be employed.

As discussed above, it will be appreciated that these treatment processes can be employed in the treatment of larger wood planks, lumber, or wood pieces. It will further be appreciated that any other forms of wood materials (e.g., wood particles, wood chips, wood flour, etc.) can also be treated in accordance with such methods. Additional treatment processes and methods are further disclosed below.

In embodiments where larger wood planks, lumber, or wood pieces are treated, the treated wood can be further cut, milled, or processed into one or more smaller pieces to be used in a building structure. Such processing can result in by-products comprising wood particles (e.g., sawdust or tailings) that comprise the treatment formulation. If desired, these by-products comprising wood particles and treatment formulation can be further processed or refined into smaller wood particles (e.g., wood flour). For instance, the by-products can be beaten, hammered, or crushed into wood flour with various mechanical implements (e.g., rollers, hammers, impactors, etc.). This resulting wood flour can comprise the treatment formulation and can be referred to as treated wood flour. If desired, this treated wood flour can then be combined with a plastic component to form a treated wood composite material.

In other embodiments, untreated wood materials (e.g., wood planks, lumber, wood pieces, etc. not comprising the treatment formulation) can be further processed after which a treatment formulation can be applied. For instance, untreated wood materials of various shapes and/or sizes can be cut or otherwise chopped into wood chips or other forms of wood particles, after which they can be treated with a treatment formulation. These treated wood chips or particles can then be processed into a treated wood flour. And in still further embodiments, untreated wood materials can be processed or refined into wood flour, after which the wood flour can be treated with the treatment formulation. It will thus be appreciated that various types and sizes of wood materials can be treated with the treatment formulations disclosed herein.

In certain embodiments, a combination of treated wood flour obtained from different sources can be used to form treated wood composite materials. For example, in some embodiments, treated wood flour obtained from by-products of treated wood (e.g., treated wood planks, lumber, or wood pieces) can be combined with wood flour that has been treated with a treatment formulation. In other embodiments, treated wood flour obtained from treated wood particles can be combined with wood flour that has been treated with a treatment formulation.

The treated wood flour can comprise a coating of treatment formulation that can cover a portion of or encapsulate the entirety of the wood flour. The treated wood flour can also be impregnated with the treatment formulation.

The treated wood components (e.g., treated wood flour) can then be combined with one or more plastic components to form a treated wood composite material. Without limitation, the treated wood composite material can comprise between about 10% and about 50% treated wood component (e.g., treated wood flour), by weight. The treated wood composite material can also comprise between about 50% and about 90% plastic components, by weight. Optional fillers and/or additives can also be used, including, but not limited to, adhesives and/or binders.

In some of such embodiments, the treated wood composite material (e.g., comprising a treated wood component and a plastic component) can comprise a tebuconazole (or another fungicide) content of between about 10 ppm and about 5,000 ppm, such as between about 10 ppm and about 2,500 ppm, between about 10 ppm and about 1,000 ppm, between about 10 ppm and about 800 ppm, between about 10 ppm and about 750 ppm, between about 10 ppm and about 500 ppm, between about 10 ppm and about 250 ppm, between about 10 ppm and about 100 ppm, between about 25 ppm and about 100 ppm, or between about 50 ppm and about 100 ppm. In further embodiments, the treated wood composite material (e.g., comprising a treated wood component and a plastic component) comprises greater than about 10 ppm, greater than about 20 ppm, greater than about 30 ppm, greater than about 40 ppm, greater than about 50 ppm, greater than about 60 ppm, greater than about 70 ppm, greater than about 80 ppm, greater than about 90 ppm, greater than about 100 ppm, greater than about 150 ppm, greater than about 200 ppm, greater than about 250 ppm, greater than about 300 ppm, or greater than about 350 ppm of tebuconazole (or another fungicide). Other amounts of tebuconazole (or another fungicide) can also be used. The amount of tebuconazole (or another fungicide) can be determined in various ways, such as through the use of gas chromatography or gas-liquid partition chromatography (GPLC).

In some embodiments, the treated wood components and plastic components can be combined and formed into pellets. In some of such embodiments, the pellets can optionally be stored until later use in forming a building structure. In other embodiments, the treated wood components and plastic components can be combined and formed directly into a building structure.

The wood composite pellets can be formed in accordance with any known method. For example, in some embodiments, pellet formation comprises a blending step and a pelletizing step. In the blending step, the treated wood component and the plastic component can be mixed to form a blend of treated wood components and plastic components. In some embodiments, the blend comprises a substantially homogenous mixture of treated wood and plastic components.

The mixture of treated wood and plastic components can then be pelletized. In some embodiments, the pellets can be formed using an extruder. For example, the mixture of treated wood and plastic components can be delivered to an extruder where they can be subjected to increased temperature. The increased temperature can cause the plastic component to soften, partially melt, or melt and form a thermoplastic melt stream comprising the treated wood component that is extruded through an extrusion head and cut into pellets. In some embodiments, the blending and pelletizing can be done by a single machine and be part of a continuous process. And in particular embodiments, the blending can be done in the extrusion chamber.

The resulting pellets can comprise a treated wood component (e.g., treated wood flour) distributed throughout the pellet. Some of the treated wood component can be disposed on the surface, and some of the treated wood component can be disposed on the interior of the pellet. A resulting building structure made from the pellets can also have a similar distribution, with some of the treated wood component being disposed on the surface of the structure, and some of the treated wood component being disposed on the interior of the structure. The treated wood component disposed on the surface can resist deterioration from the outside, such as that caused by exposure to humid or dry air, moisture, weather, fungal infestation, and/or insects and pests.

Various types of plastic materials can be used as the plastic component of the composite materials. Exemplary types of plastic materials that can be used include thermoplastic materials. The plastic components can also be referred to as polymer components. In some embodiments, the plastic materials can comprise one or more of polyethylene (e.g., low density polyethylene (LDPE), high density polyethylene (HDPE), etc.), polypropylene, polyvinyl (e.g., polyvinyl chloride), polystyrene, polylactic acid, polyurethane, and combinations thereof. In a particular embodiment, the plastic component comprises a polyvinyl material, such as polyvinyl chloride. Other plastic materials can also be used.

The treated wood composite materials can thereafter be used or incorporated into any variety of building structures. Without limitation, it will be appreciated that the treated wood composite materials can be incorporated into structures, including, but not limited to, a door frame or a portion of a door frame, a door panel (or a portion thereof), a door skin, a window frame or a portion of a window frame, or a window part, such as a sash, glass stop or a simulated divided light (SDL) bar (e.g., a muntin), siding (or a portion thereof), flooring, decking (or a portion thereof), a facia board, a shutter, a shingle, or a cladding. For example, in some embodiments, the treated wood composite materials (e.g., pellets comprising the treated wood composite materials) can be heated into a melt and extruded into a lineal extruded building structure (e.g., a window or door frame member, or sash frame). Other processing methods can also be used, such as injection molding techniques.

Additional methods for applying a treatment formulation to wood particles (e.g., chips, wood flour, etc.) are further disclosed below and depicted in the following drawings, wherein like parts are designated by like numerals throughout. It will be readily understood that the components of the present disclosure, as generally described and illustrated in these drawings could be arranged and designed in a wide variety of different configurations. Thus, the following more detailed description of the embodiments of the figures is not intended to limit the scope of the disclosure, but is merely representative of possible embodiments of the disclosure. In some cases, well-known structures, materials, or operations are not shown or described in detail. Additionally, while the various aspects of the embodiments are presented in drawings, the drawings are not necessarily drawn to scale unless specifically indicated.

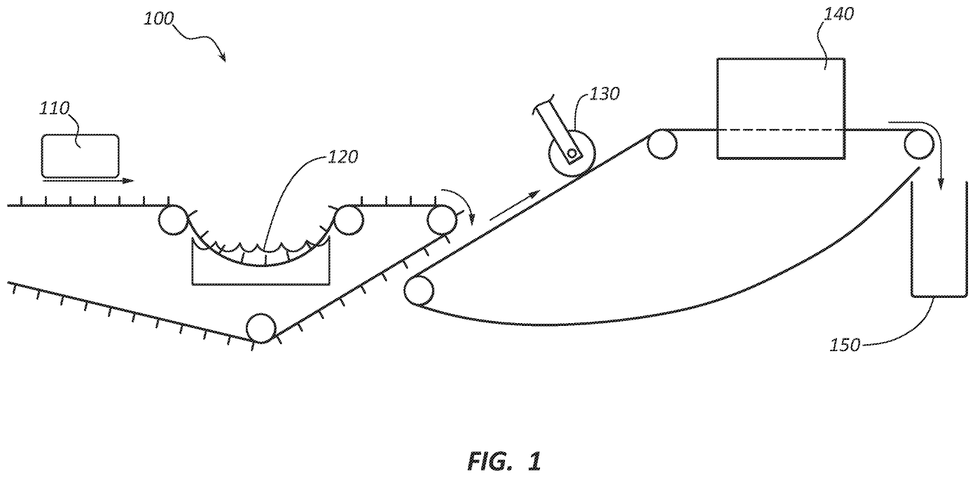

FIG. 1 depicts a process 100 of applying the treatment formulation 120 to a wood component 110 in accordance with one embodiment of the present disclosure. The wood component 110 can comprise any of the various types and/or sizes of wood particles previously described. In some embodiments, the wood component 110 comprises wood particles selected from at least one of wood chips, curls, flakes, slivers, strands, shavings (e.g., sawmill shavings), sawdust, wood flour, and combinations thereof. In certain embodiments, the wood component 110 comprises wood particles (e.g., chips, flakes, etc.) having a size of between about a 4 mesh (e.g., 0.187 inch mesh opening) and about a 1.5 inch mesh opening. In other embodiments, the wood component 110 comprises wood flour.

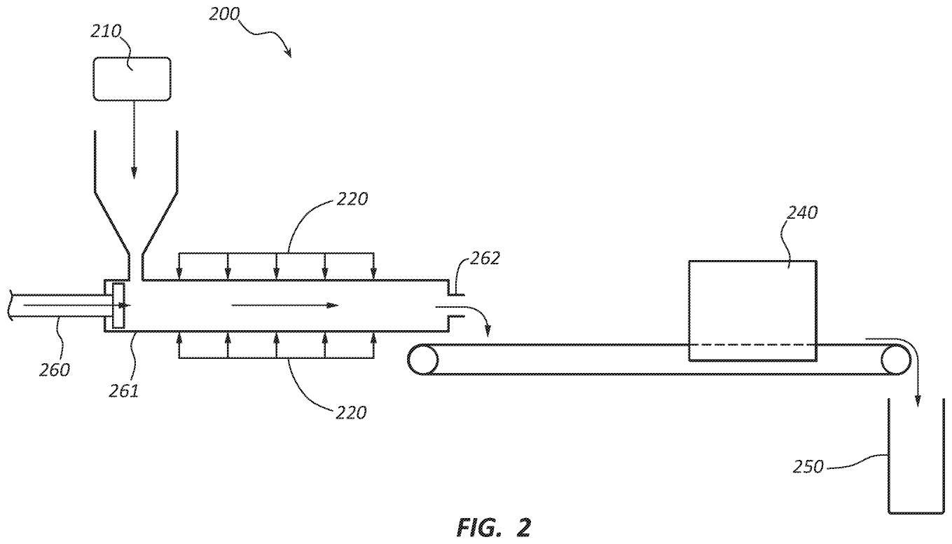

In various embodiments, the wood component 110 is substantially dried prior to being subjected to the method of FIG. 1 (or FIGS. 2-6). For example, the wood component 110 can be dried to less than about 15%, less than about 12%, less than about 10%, less than about 8%, or less than about 6% moisture content prior to being treated in accordance with the methods disclosed herein.

As shown in FIG. 1, the process 100 can comprise a step of contacting a wood component 110 with a treatment formulation 120. For example, as shown in the illustrated embodiment, the wood component 110 can be transferred and subjected to a container or treatment vessel comprising a treatment formulation 120. In certain of such embodiments, a conveyor can be used to transfer the wood component 110 to the treatment formulation 120. In some embodiments, the wood component 110 is contacted with the treatment formulation 120 for a time period that is sufficient for the treatment formulation 120 to saturate, coat, and/or impregnate the wood component 110. The wood component 110 and treatment formulation 120 can also create a slurry in the treatment vessel.

As further shown in FIG. 1, the process 100 can comprise a step of removing excess treatment formulation 120 from the wood component 110. For instance, in certain embodiments the saturated wood component 110 can be transferred to a compression device 130. The compression device 130 can be used to compress the wood component 110 thereby removing the excess treatment formulation 120. In certain embodiments, the saturated wood component 110 is transferred on a conveyor (which can be on an incline), and the compression device 130 comprises a roller. If desired, the excess treatment formulation 120 can be recycled and returned to the container for further use in subsequent treatment processes.

With continued reference to FIG. 1, the process 100 can further comprise a step of drying the treated wood component 110. For instance, after removing the excess treatment formulation 120, the treated wood component 110 can be delivered to a drying mechanism 140 (such as a dehumidifier, a kiln, an oven, etc.). In some embodiments, the wood component 110 is air-dried at ambient temperatures. In other embodiments, the drying mechanism 140 is heated to between about 100° F. and about 240° F., between about 140° F. and about 220° F., or between about 160° F. and about 200° F. during the drying step. Other temperatures can also be used. The drying step can dry the wood component to less than about 15%, less than about 12%, less than about 10%, less than about 8%, or less than about 6% moisture content. It will be appreciated that similar drying steps can also be used in the methods of FIGS. 2-6 discussed below.

The process 100 can further comprise a step of storing the dried, treated wood component 110 in a storage container 150 for later use. For example, in embodiments where non wood flour particles are treated, the treated wood particles can be further processed into treated wood flour. In embodiments where wood flour is treated, the treated wood flour can be optionally combined with other treated wood flour (e.g., obtained from by-products of treated wood, etc.) and/or can be combined with a plastic component to form a treated wood composite material.

FIG. 2 illustrates a process 200 of applying a treatment formulation 220 to a wood component 210 in accordance with another embodiment of the present disclosure. The process 200 can, in certain respects, resemble the process 100 described above in FIG. 1. Accordingly, like features are designated with like reference numerals, with the leading digits incremented to “2.” Relevant disclosure set forth above regarding similarly identified features thus may not be repeated hereafter. Moreover, specific features of the process 200 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the process 200. Any suitable combination of the features and variations of the same described with respect to the process 100 can be employed with the process 200, and vice versa. This pattern of disclosure applies equally to further embodiments depicted in subsequent figures and described hereafter, wherein the leading digits may be further incremented.

As shown in FIG. 2, the process 200 can comprise a step of contacting a wood component 210 with a treatment formulation 220. For example, as shown in the illustrated embodiment, the wood component 210 can be fed into a mixing vessel 261. The treatment formulation 220 can also be fed into the mixing vessel 261, where it is mixed with the wood component 210.

In some embodiments, the mixing vessel 261 comprises an elongated and/or tubular structure that comprises a pushing member 260. The pushing member 260 can comprise, for example, a piston or a rotary screw. The pushing member 260 can force the wood component 210 through the mixing vessel 261 from a first end to a second end, as indicated in FIG. 2. As the wood component 210 travels down the mixing vessel 261, the treatment formulation 220 can be introduced into the mixing vessel 261 through one or more ports. The treatment formulation 220 can also saturate, coat, or impregnate the wood component 210. For example, the pushing member 260 can create an increased pressure in the mixing vessel 261 as the wood component is forced towards an orifice 262. As shown in FIG. 2, the orifice 262 is at an end of the mixing vessel 261 and can comprise a reduced diameter, which can cause a pressure buildup within the mixing vessel 261 as the wood component 210 is pushed by the pushing member 260. This pressure buildup can aid in saturating, coating, or impregnating the wood component 210 with the treatment formulation 220.

The process 200 can further comprise a step of drying the treated wood component 210 (similar to FIG. 1). For instance, after saturating the wood component 210 with the treatment formulation 220, the saturated wood component 210 can be forced out of the mixing vessel 261 and delivered to a drying mechanism 240. The process 200 can further comprise a step of storing the dried, treated wood component in a storage container 250 for later use.

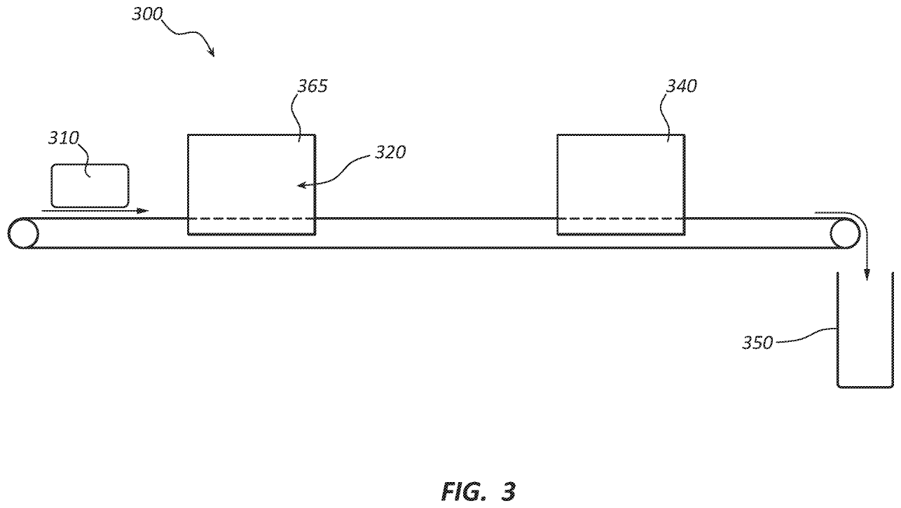

FIG. 3 illustrates a process 300 of applying a treatment formulation 320 to a wood component 310 in accordance with another embodiment of the present disclosure. As shown in FIG. 3, the process 300 can comprise a step of contacting a wood component 310 with a treatment formulation 320. For example, as shown in the illustrated embodiment, the wood component 310 can be fed into a compartment or chamber 365 comprising a treatment formulation 320 that is volatized. The volatized treatment formulation 320 can permeate and/or penetrate the wood component 320. In some embodiments, the volatized treatment formulation 320 is at a temperature of between about 200° F. and about 270° F., or between about 210° F. and about 260° F. In other embodiments, the volatized treatment formulation 320 is at a temperature of greater than about 200° F., greater than about 210° F., greater than about 220° F., greater than about 230° F., or greater than about 240° F. The wood component 310 can also be subjected to the volatized treatment formulation 320 for a period that is sufficient to saturate, coat, and/or impregnate the wood component 310. In some embodiments, the wood component 310 is subjected to the volatized treatment formulation 320 for at least about 10 minutes, at least about 15 minutes, at least about 20 minutes, at least about 25 minutes, or at least about 30 minutes, or longer. In certain embodiments, the wood component 320 can be agitated to aid in the treatment the wood flour 310.

The process 300 can further comprise a step of drying the treated wood component 310 (similar to FIG. 1). For instance, the treated wood component 310 can be transferred from the chamber 365 to a drying mechanism 340. The process 300 can further comprise a step of storing the dried, treated wood component in a storage container 350 for later use.

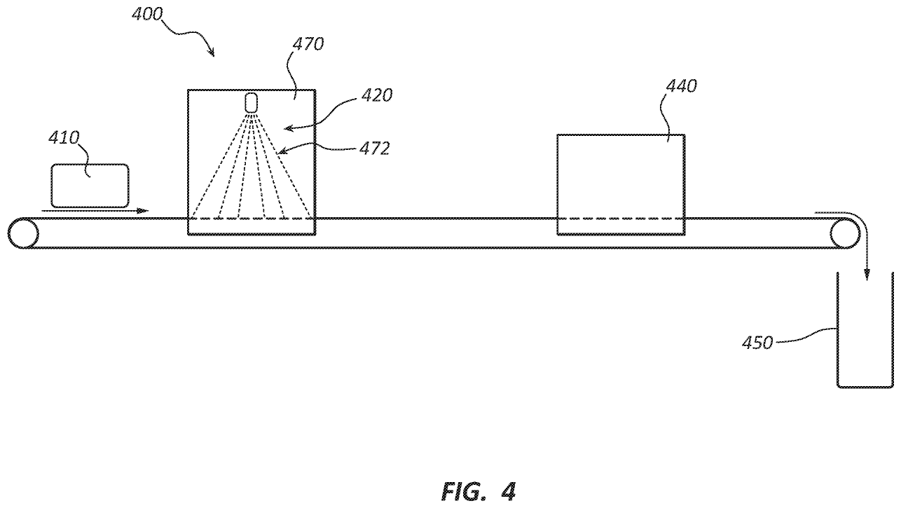

FIG. 4 illustrates a process 400 of applying a treatment formulation 420 to a wood component 410 in accordance with another embodiment of the present disclosure. As shown in FIG. 4, the process 400 can comprise a step of contacting a wood component 410 with a treatment formulation 420. For example, as shown in the illustrated embodiment, the wood component 410 can be fed into a compartment or chamber 470 comprising a treatment formulation 420. As further shown in FIG. 4, in some embodiments, the treatment formulation 420 can be comprised in a spray 472 that is applied to the wood component 410. The wood component 410 can be comprised in a mat that is less than about 3 inches, less than about 2 inches, or less than about 1 inch in thickness that is transferred through the chamber 470. The wood component 410 can also be agitated as it is being treated with the treatment formulation 420 to ensure adequate saturation and/or coating of the wood component 410 with the treatment formulation 420.

The process 400 can further comprise a step of drying the treated wood component 410 (similar to FIG. 1). For instance, the treated wood component 410 can be transferred from the chamber 470 to a drying mechanism 440. The process 400 can further comprise a step of storing the dried, treated wood component in a storage container 450 for later use.

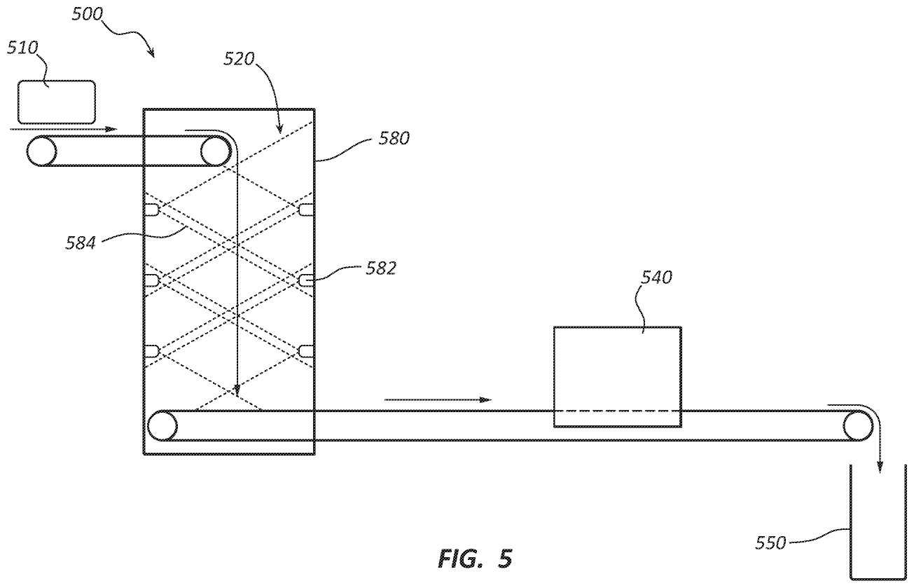

FIG. 5 illustrates a process 500 of applying a treatment formulation 520 to a wood component 510 in accordance with another embodiment of the present disclosure. As shown in FIG. 5, the process 500 can comprise a step of contacting a wood component 510 with a treatment formulation 520. For example, as shown in the illustrated embodiment, the wood component 510 can be fed into a compartment or chamber 580 comprising a treatment formulation 520. As further shown in FIG. 5, in some embodiments, the treatment formulation 520 can be comprised in a spray 584 that is applied to the wood component 510 as the wood component 510 falls or otherwise passes through the chamber 580. For instance, the chamber 580 can comprise one or more nozzles 582 that can spray 584 one or more streams of treatment formulation 520 at the wood component 510 from multiple directions. In other embodiments, the chamber 580 can comprise one or more nozzles 582 that can form a mist of the treatment formulation 520. The wood component 510 can be saturated and/or coated by the treatment formulation 520.

The process 500 can further comprise a step of drying the treated wood component 510 (similar to FIG. 1). For instance, the treated wood component 510 can be transferred from the chamber 580 to a drying mechanism 540. The process 500 can further comprise a step of storing the dried, treated wood component in a storage container 550 for later use.

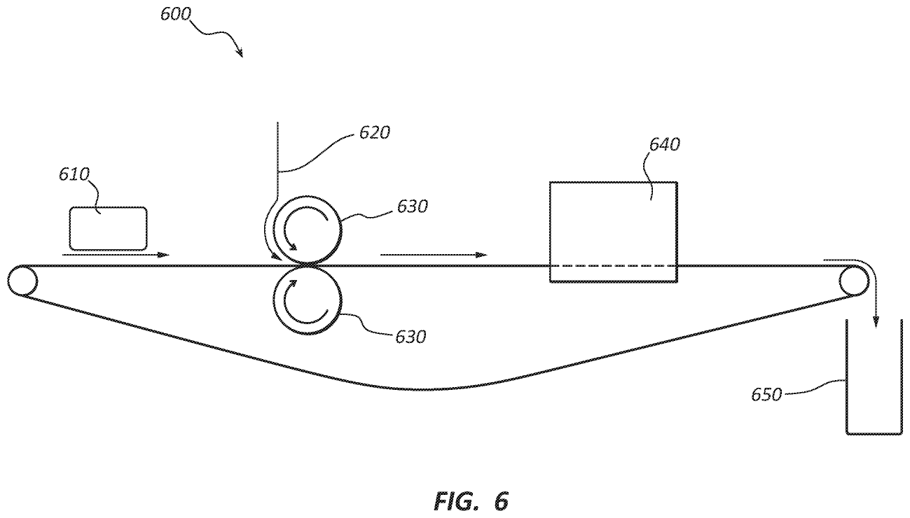

FIG. 6 illustrates a process 600 of applying a treatment formulation 620 to a wood component 610 in accordance with another embodiment of the present disclosure. As shown in FIG. 6, the process 600 can comprise a step of contacting a wood component 610 with a treatment formulation 620. For example, as shown in the illustrated embodiment, the wood component 610 can be fed into a series of applicators 630 (e.g., rollers). As the wood component 610 is fed to the applicator 630, the treatment formulation can be cascaded over or disposed on a surface of the applicator on the entry side with the wood component 610. The applicator 630 can deliver the treatment formulation 620 to the wood component and provide pressure to saturate, coat, and/or impregnate the wood component 610 with the treatment formulation 620.

The process 600 can further comprise a step of drying the treated wood component 610 (similar to FIG. 1). For instance, the treated wood component 610 can be transferred from the applicator 630 to a drying mechanism 640. The process 600 can further comprise a step of storing the dried, treated wood component in a storage container 650 for later use.

It will be appreciated that in any of the above identified embodiments depicted in FIGS. 1-6, at least a portion of the process 100, 200, 300, 400, 500, 600 can be subjected to vacuum conditions (or reduced pressure). For example, the step of contacting the wood component 110, 210, 310, 410, 510, 610 with the treatment formulation 120, 220, 320, 420, 520, 620 can take place in a treatment vessel that can be subjected to a vacuum (or reduced pressure). Increased pressure and/or increased temperatures can also be incorporated into the methods 100, 200, 300, 400, 500, 600, such as, for example, in the step of contacting the wood component 110, 210, 310, 410, 510, 610 with the treatment formulation 120, 220, 320, 420, 520, 620.

As previously mentioned, it will also be appreciated that the wood component can comprise other types of lignocellulosic materials, including, but not limited to, straw, hemp, sisal, cotton stalk, wheat, bamboo, jute, salt water reeds, palm fronds, flax, nut shells, and combinations thereof. These lignocellulosic materials can be used in combination with, or in place of, the wood particles and/or wood flour. For example, fibers, particles, and/or flour comprising one or more of the various lignocellulosic materials can be used. These lignocellulosic materials can then be treated in accordance with the various methods disclosed herein.

In each of the above identified processes 100, 200, 300, 400, 500, 600, the volume and/or speed of the process can also be controlled and varied as desired. For instance, in some embodiments, the processes 100, 200, 300, 400, 500, 600 can be configured such that between about 100 lbs and about 500 lbs of wood component 110, 210, 310, 410, 510, 610 can be treated per hour.

It will further be appreciated that in any of the processes 100, 200, 300, 400, 500, 600, the system can comprise a closed system. In such embodiments, there may be recycling of one or more of the resources used in the treatment process. For example, water recovered from drying step can be recycled and used with the treatment formulation. As another example, any unabsorbed treatment formulation may be recovered from the treatment vessel and reused in a subsequent treatment process.

The processes 100, 200,300, 400, 500, 600 (or a portion thereof) can also be automated if desired. For example, one or more of the steps can be controlled by a computer. In certain of such embodiments, a user may input instructions at various points in the production line. The user may enter instructions including options for the run, how reports should be printed out, and the like. The computer may comprise software encoded on a computer-readable medium for programming the system. For example, software specifically developed for manufacturing, process control, operator-machine interfacing, and data acquisition may be used. Also, at each step in the production schedule, data may be stored in the computer using a storage device. As is understood in the art, a processor and I/O controller can be used for multiple aspects of computer function.

Methods of manufacturing wood composite materials are also disclosed herein. In particular, it is contemplated that any of the components, principles, and/or embodiments discussed above may be utilized in either a wood composite material or a method of manufacturing the same. One exemplary method of manufacturing a wood composite material comprises a step of contacting a wood particle with a treatment formulation, wherein the treatment formulation comprises tebuconazole. The method can further comprise a step of drying the treated wood particle. The method can further comprise a step of combining the treated wood particle with a plastic component to form a wood composite material, wherein the treated wood composite comprises between about 10% and about 50% wood component by weight. Other method steps can also be employed.

References to approximations are made throughout this specification, such as by use of the terms “about.” For each such reference, it is to be understood that, in some embodiments, the value, feature, or characteristic may be specified without approximation. For example, where qualifiers such as “about” or “substantially” are used, these terms include within their scope the qualified words in the absence of their qualifiers. All disclosed ranges also include both endpoints.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description.

Without further elaboration, it is believed that one skilled in the art can use the preceding description to utilize the invention to its fullest extent. The claims and embodiments disclosed herein are to be construed as merely illustrative and exemplary, and not a limitation of the scope of the present disclosure in any way. It will be apparent to those having ordinary skill in the art, with the aid of the present disclosure, that changes may be made to the details of the above-described embodiments without departing from the underlying principles of the disclosure herein. In other words, various modifications and improvements of the embodiments specifically disclosed in the description above are within the scope of the appended claims. The scope of the invention is therefore defined by the following claims and their equivalents.

What is claimed is:

1. A treated wood composite material, comprising:
a wood component comprising wood flour, wherein the wood component comprises a treatment formulation comprising tebuconazole; and
a plastic component,
wherein the wood flour comprises a mesh size of between about 20 and about 270,
wherein the treated wood composite comprises between about 10% and about 50% wood component by weight.

2. The treated wood composite material of claim 1, wherein the wood flour comprises a diameter to length aspect ratio of between about 1:1 and about 1:5.

3. The treated wood composite material of claim 1, wherein the treated wood composite material is in the form of a pellet.

4. The treated wood composite material of claim 1, wherein the treated wood composite material is in the form of a building structure.

5. The treated wood composite material of claim 1, further comprising a second wood component, wherein the second wood component comprises a milling by-product of treated wood.

6. The treated wood composite material of claim 1, wherein the plastic component comprises at least one of polyethylene, polypropylene, polyvinyl, polyvinyl chloride, polystyrene, polylactic acid, or polyurethane.

7. The treated wood composite material of claim 6, wherein the plastic component comprises polyvinyl chloride.

8. The treated wood composite material of claim 1, wherein the wood component comprises between about 250 ppm and about 1,500 ppm of tebuconazole.

9. The treated wood composite material of claim 1, wherein the treatment formulation further comprises imidacloprid.

10. A method of manufacturing a wood composite material, comprising:
contacting wood particles with a treatment formulation, wherein the treatment formulation comprises tebuconazole;
drying the treated wood particles;
combining the treated wood particles with a plastic component to form a wood composite material,
wherein the treated wood composite comprises between about 10% and about 50% wood particles by weight.

11. The method of claim 10, wherein contacting the wood particles with the treatment formulation comprises subjecting the wood particles to a treatment vessel comprising the treatment formulation and forming a slurry.

12. The method of claim 10, wherein contacting the wood particles with the treatment formulation comprises mixing the wood particles with the treatment formulation in an elongate mixing tube, wherein the elongate mixing tube comprises a pusher member that forces the wood particles from a first end to a second end comprising an orifice.

13. The method of claim 10, wherein contacting the wood particles with the treatment formulation comprises subjecting the wood particles to a treatment formulation that is volatized.

14. The method of claim 10, wherein contacting the wood particles with the treatment formulation comprises spraying the wood particles with the treatment formulation and optionally agitating the wood particles as they are being sprayed.

15. The method of claim 10, wherein contacting the wood particles with the treatment formulation comprises spraying the wood particles with the treatment formulation as the wood particles fall through a treatment chamber.

16. The method of claim 10, wherein contacting the wood particles with the treatment formulation comprises feeding the wood particles into an applicator that applies treatment formulation to the wood particles and compresses the wood particles.

17. The method of claim 10, wherein the wood particles comprise wood flour comprising a mesh size of between about 20 and about 270.

18. The method of claim 10, further comprising:
obtaining a treated wood flour, wherein the treated wood flour comprises a milling by-product of treated wood; and
combining the treated wood flour with the treated wood particles.

19. The method of claim 18, wherein the wood particles comprise a wood flour.

20. A method of manufacturing a wood composite material, comprising:
treating a first wood component with a first treatment formulation, comprising:
subjecting the first wood component to a vacuum;
contacting the first wood component with the first treatment formulation; and
subjecting the first wood component to positive pressure while the first treatment formulation is in contact with the first wood component to form a first treated wood component;
forming a first treated wood flour from the first treated wood component;
treating a second wood component comprising a second wood flour with a second treatment formulation to form a second treated wood flour;
combining the first treated wood flour with the second treated wood flour to form a third treated wood flour; and
blending the third treated wood flour with a plastic component to form a wood composite material.
